(19) United States
(12) Patent Application Publication
(10) Pub. No.: US 2022/0413219 A1
(43) Pub. Date: Dec. 29, 2022

(54) OPTICAL COUPLER AND LIGHT OUTPUT DEVICE

(71) Applicant: FURUKAWA ELECTRIC CO., LTD., Tokyo (JP)

(72) Inventor: Kohei KAWASAKI, Tokyo (JP)

(73) Assignee: FURUKAWA ELECTRIC CO., LTD., Tokyo (JP)

(21) Appl. No.: 17/894,478

(22) Filed: Aug. 24, 2022

Related U.S. Application Data
(63) Continuation of application No. PCT/JP2021/006463, filed on Feb. 19, 2021.

(30) Foreign Application Priority Data
Feb. 28, 2020 (JP) 2020-034233

(51) Int. Cl. G02B 6/122

(52) U.S. Cl. CPC G02B 6/1228

(57) ABSTRACT

An optical coupler includes: input-type optical fibers; an output-type optical fiber; and radiant light processing units. The input-type optical fibers are bundled at leading end side to form a fiber bundle portion, and leading end portion of the fiber bundle portion is connected to the output-type optical fiber. In at least either the input-type optical fibers or the output-type optical fiber, a tapered portion is formed in which cross-sectional area is tapered to become narrower in light traveling direction indicating direction from the input-type optical fibers toward the output-type optical fiber. The number of the tapered portion is equal to or greater than two. Each radiant light processing unit is disposed to mutually overlap with one of the tapered portions or away from one of the tapered portions in the light traveling direction, and is disposed on outer periphery of the input-type optical fibers or the output-type optical fiber.

This application is a continuation of International Application No. PCT/JP2021/006463, filed on Feb. 19, 2021 which claims the benefit of priority of the prior Japanese Patent Application No. 2020-034233, filed on Feb. 28, 2020, the entire contents of which are incorporated herein by reference.

### BACKGROUND

The present disclosure relates to an optical coupler and a light output device.

As an optical coupler, a TFB (Tapered Fiber bundle portion) is known (U.S. Pat. No. 5,864,644). That optical coupler includes a plurality of input-type optical fibers and an output-type optical fiber. The input-type optical fibers are bundled to form a fiber bundle portion. The leading end portion of the fiber bundle portion is connected to the output-type optical fiber. The fiber bundle portion has a tapered portion that is tapered in such a way that the cross-sectional area of each input-type optical fiber becomes narrower in the leading end portion. In this optical coupler, the lights output from a plurality of light sources may be coupled to enhance the total optical power, and the coupled light may be output to the output-type optical fiber. The optical coupler is sometimes used in an optical fiber laser or an optical fiber amplifier.

### SUMMARY

In the industrial field, there has been a demand for achieving an increase in the power and the luminance of the laser light. In order to achieve an increase in the luminance of the laser light, for example, it is possible to think of a method for further narrowing the cross-sectional area at the leading end portion of the tapered portion of an optical coupler.

However, if the cross-sectional area at the leading end portion of the tapered portion is further narrowed, then the taper angle of the input-type optical fibers further increases, thereby resulting in the generation of a light having a greater radiation angle in the tapered portion. Such a light having a large radiation angle not only leaks easily from the input-type optical fibers, but also has trouble in getting coupled even if it happens to reach the output-type optical fiber. As a result, the leaked light or the uncoupled light acts as the radiant light oriented toward the outside of the optical fibers. Such radiant light reaches the surrounding of the optical coupler, and makes inappropriate effects such as heating of the portions it has reached. That becomes a crucial factor for a decline the reliability of the optical coupler.

There is a need for an optical coupler that is suitable in enhancing the luminance of the laser light and that is prevented from undergoing a decline in reliability, and to provide a light output device in which the optical

According to one aspect of the present disclosure, there is provided an optical coupler including: a plurality of input-type optical fibers; an output-type optical fiber; and two or more radiant light processing units, wherein the plurality of input-type optical fibers are bundled at leading end side to form a fiber bundle portion, and leading end portion of the fiber bundle portion is connected to the output-type optical fiber, in at least either the plurality of input-type optical fibers or the output-type optical fiber, a tapered portion is formed in which cross-sectional area is tapered to become narrower in light traveling direction indicating direction from the plurality of input-type optical fibers toward the output-type optical fiber, number of the tapered portion is equal to or greater than two, and each of the two or more radiant light processing units is disposed to mutually overlap with one of the two or more tapered portions in the light traveling direction or is disposed away from one of the two or more tapered portions in the light traveling direction, and is disposed on outer periphery of the plurality of input-type optical fibers or outer periphery of the output-type optical fiber.

### BRIEF DESCRIPTION OF THE DRAWINGS

FIG. 1 is a schematic diagram of a light output device that includes an optical coupler according to a first embodiment.

FIG. 2 is a schematic diagram of the optical coupler according to the first embodiment.

FIG. 3 is a schematic diagram of an optical coupler according to a second embodiment.

FIG. 4 is a schematic diagram of an optical coupler according to a third embodiment.

FIG. 5 is a diagram illustrating an exemplary configuration of a light source device.

FIG. 6A is a diagram illustrating an example of the arrangement of input-type optical fibers.

FIG. 6B is a diagram illustrating an example of the arrangement of the input-type optical fibers.

FIG. 6C is a diagram illustrating an example of the arrangement of the input-type optical fibers.

FIG. 6D is a diagram illustrating an example of the arrangement of the input-type optical fibers.

### DETAILED DESCRIPTION

Exemplary embodiments are described below in detail with reference to the accompanying drawings. However, the present disclosure is not limited by the embodiments described below. In the drawings, identical elements or corresponding elements are referred to by the same reference numerals. Moreover, each drawing is schematic in nature, and it needs to be kept in mind that the relationships among the dimensions of the elements or the ratio of the elements may be different than the actual situation.

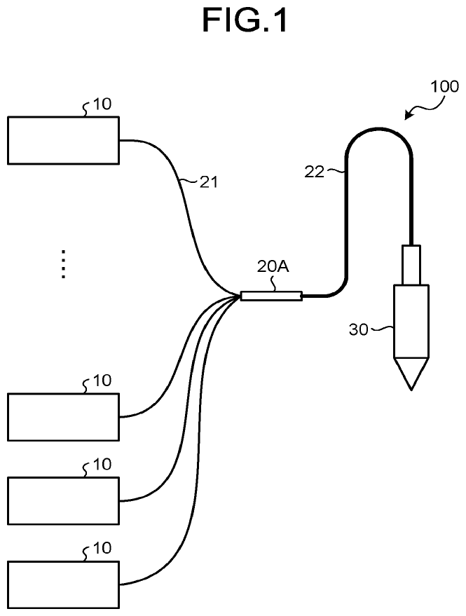

FIG. 1 is a schematic diagram of a light output device that includes an optical coupler according to a first embodiment. A light output device 100 is configured as a laser device used in laser beam machining, and includes a plurality of light source devices 10, an optical coupler 20A according to the first embodiment, and a machining head 30.

The optical coupler 20A includes a plurality of input-type optical fibers 21 and an output-type optical fiber 22. Each light source device 10 includes, for example, a semiconductor laser or a fiber laser, and outputs a laser light. Herein, there is no particular restriction on the wavelength of the laser light. The light source devices 10 and the input-type optical fibers 21 are connected in such a way that the light output from each light source device 10 is input to one of the input-type optical fibers 21. In the first embodiment, it is assumed that there are seven light source devices 10 and seven input-type optical fibers 21.

The optical coupler 20A synthesizes the laser lights output from the light source devices 10, and outputs the synthesized laser light to the output-type optical fiber 22. The output-type optical fiber 22 transmits the synthesized laser light to the machining head 30. Then, the machining head 30 irradiates the machining target with the laser light transmitted thereto. As a result, laser beam machining is carried out.

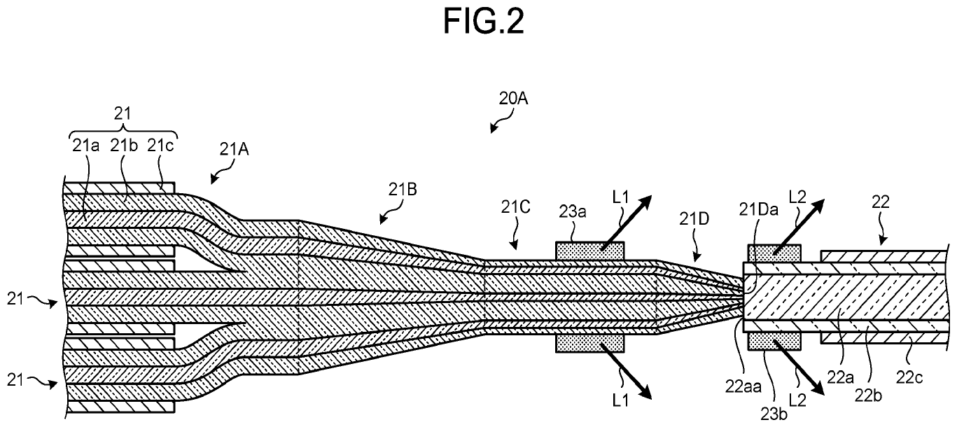

FIG. 2 is a schematic diagram of the optical coupler according to the first embodiment. The optical coupler 20A includes the seven input-type optical fibers 21, the output-type optical fiber 22, and radiant light processing units 23a and 23b. The radiant light processing units 23a and 23b represent an example of two or more radiant light processing units.

Among the seven input-type optical fibers 21, a single input-type optical fiber 21 is placed in the center, and six input-type optical fibers 21 are placed on the outer periphery side of the central input-type optical fiber 21, so that the closest packing arrangement is achieved. In FIG. 2 is illustrated a cut surface in the plane passing through the optical axis of the central input-type optical fiber 21. In FIG. 2, three input-type optical fibers 21 are illustrated.

In FIG. 2, the direction from the central input-type optical fiber 21 toward the output-type optical fiber 22 is defined as the light traveling direction.

Each input-type optical fiber 21 includes a core portion 21a, a cladding layer 21b formed on the outer periphery of the core portion 21a, and a resin covering layer 21c formed on the outer periphery of the cladding layer 21b. Although the input-type optical fibers 21 are, for example, multimode optical fibers, they may alternatively be single-mode optical fibers. Herein, it is assumed that each input-type optical fiber 21 is a multimode optical fiber having a predetermined NA (numerical aperture).

The output-type optical fiber 22 includes a core portion 22a, a cladding layer 22b formed on the outer periphery of the core portion 22a, and a resin covering layer 22c formed on the outer periphery of the cladding layer 22b. The core portion 22a has an apical surface 22aa. On the sides of the apical surface 22aa, the resin covering layer 22c is removed over a predetermined length. The output-type optical fiber 22 is assumed to be a multimode optical fiber having the NA to be equal to or greater than the NA of the input-type optical fibers 21.

The seven input-type optical fibers 21 are bundled at the leading end side to form fiber bundle portions 21A, 21B, 21C, and 21D. From midway of the fiber bundle portion 21A and across the fiber bundle portions 21B, 21C, and 21D, the resin covering layer 21c is removed. The fiber bundle portion 21D that represents the leading end portion among the fiber bundle portions 21A, 21B, 21C, and 21D is connected to the output-type optical fiber 22. Herein, the fiber bundle portion 21D and the output-type optical fiber 22 are fusion-spliced at apical surfaces 21Da and 22aa.

The fiber bundle portion 21B is a tapered portion in which the cross-sectional area of each of the seven input-type optical fibers 21 is tapered to become narrower in the light traveling direction. The fiber bundle portion 21C is an isodiametric portion in which the cross-sectional area of each of the seven input-type optical fibers 21 remains substantially equal in the light traveling direction. The fiber bundle portion 21D is also a tapered portion of the seven input-type optical fibers 21. That is, in the optical coupler 20A, the seven input-type optical fibers 21 have two tapered portions. The fiber bundle portions 21B and 21D represent an example of two or more tapered portions. The length of the tapered portions in the light traveling direction is, for example, in the range of 1 mm to 30 mm. However, there is no particular restriction on the length. It is desirable to set the length of the tapered portions in such a way that any abrupt increase in the radiation angle of the propagating light may be held down.

The radiant light processing unit 23a is disposed to enclose the outer periphery of the fiber bundle portion 21C that is an isodiametric portion. That is, the radiant light processing unit 23a is placed away from the fiber bundle portion 21B, which is a tapered portion, in the light traveling direction; and is placed on the outer periphery of the seven input-type optical fibers 21.

The radiant light processing unit 23b is placed to enclose, in the output-type optical fiber 22, the outer periphery of that portion of the cladding layer 22b from which the resin covering layer 22c has been removed. That is, the radiant light processing unit 23b is placed away from the fiber bundle portion 21D, which is a tapered portion, in the light traveling direction and is placed on the outer periphery of the output-type optical fiber 22.

The radiant light processing units 23a and 23b are made of a light-removal-type resin. The light-removal-type resin is a resin in which a filler is added that has a small refractive-index difference with the cladding layers 21b and 22b and that causes scattering and attenuation of the input light. The light-removal-type resin is, for example, a silicon-based heat-conductive compound in which boron nitride is added as the filler.

In the optical coupler 20A configured in the manner explained above, because of the two tapered portions 21B and 21D, it becomes possible to enhance the luminance of the multiplexed light obtained as a result of multiplexing the laser lights input from the seven input-type optical fibers 21.

Moreover, a laser light L1 that is generated in the fiber bundle portion 21B and that has a large radiation angle may be efficiently retrieved from the fiber bundle portion 21C using the radiant light processing unit 23a. In an identical manner, a laser light L2 that is generated in the fiber bundle portion 21D and that has a large radiation angle may be efficiently retrieved from the output-type optical fiber 22 using the radiant light processing unit 23b. In this way, with respect to the positions at which the laser light having a large radiation angle gets generated, the radiant light processing units 23a and 23b that retrieve the laser light having a large radiation angle are disposed at intended positions in the light traveling direction. As a result, the leaked light or the uncoupled light may be prevented from reaching unintended portions. That enables holding down a decline in the reliability of the optical coupler 20A.

Herein, it is desirable that the taper ratios of the fiber bundle portions 21B and 21D increase in inverse proportion to the distance to the output-type optical fiber 22. The taper ratio is defined as {(maximum diameter)−(minimum diameter)}/(length in an axial direction). The laser light in the fiber bundle portion 21D, which is closer to the output-type optical fiber 22, has less power than the laser light in the fiber bundle portion 21B, which is farther from the output-type optical fiber 22. Hence, even when a large taper ratio is set, the amount of heat generation may still be easily held down. That is, with such a configuration, while reducing the differences in the amounts of heat generation among the dispersed locations of heat generation and while holding down the total amount of heat generation, the optical coupler 20A may be configured in a more compact manner in an axial direction.

Moreover, when the taper ratios of the fiber bundle portions 21B and 21D increase in inverse proportion to the distance to the output-type optical fiber 22, it is desirable that the lengths in an axial direction of the radiant light processing units 23a and 23b increase in inverse proportion to the distance to the output-type optical fiber 22. That is because of the following reason. If the taper ratio is large, then the radiation angle is large. Hence, at the outer periphery of the cladding layer 22b, the radiated laser L2 spreads out more as compared to the laser light L1. Consequently, if the radiant light processing unit 23b is long, the laser light L2 may be retrieved in a more reliable manner.

As explained above, the optical coupler 20A according to the first embodiment is suitable in enhancing the luminance of the input laser light and is prevented from undergoing a decline in reliability. The light source device 10 that includes the optical coupler 20A is capable of outputting a high-luminance laser light from the machining head 30 and is prevented from undergoing a decline in device reliability. In the optical coupler 20A according to the first embodiment, the locations of heat generation are dispersed, so that the occurrence of local heating in the vicinity of the optical coupler may be held down.

Such a configuration is suitable when the wavelength of the laser light is equal to or smaller than 500 nm, such as in the case of blue laser light. Moreover, such a configuration is suitable when the output of the laser light from the optical coupler 20A is equal to or greater than 100 [W], and is more suitable when that output is equal to or greater than 200 [W]. Regarding the laser light having the wavelength equal to or smaller than 500 [nm], since the absorption rate for a metallic material is relatively high, any leakage of the laser light from the optical coupler in an optical device, such as the light output device 100, is likely to cause a greater rise in temperature. In that regard, in the optical coupler 20A according to the first embodiment, even when the laser light has the wavelength of 500 [nm] and the output of the laser light is relatively high, it becomes possible to hold down the rise in temperature attributed to the leaked light from the optical coupler 20A in an optical device.

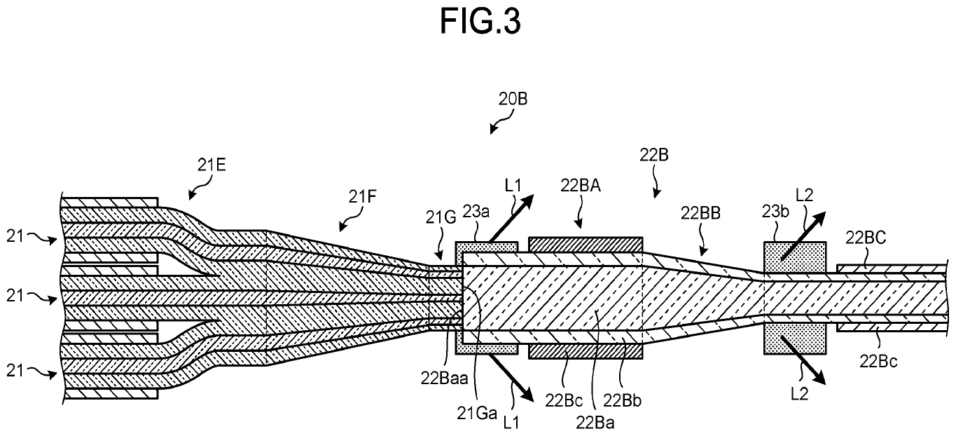

FIG. 3 is a schematic diagram of an optical coupler according to a second embodiment. An optical coupler 20B may be used in place of the optical coupler 20A in the light output device 100.

The optical coupler 20B includes the seven input-type optical fibers 21, an output-type optical fiber 22B, and the radiant light processing units 23a and 23b. Herein, the configuration and the arrangement of the seven input-type optical fibers 21 as well as the definition of the light traveling direction is identical to the optical coupler 20A. Hence, that explanation is not given again.

The output-type optical fiber 22B includes a core portion 22Ba, a cladding layer 22Bb formed on the outer periphery of the core portion 22Ba, and a resin covering layer 22Bc formed on the outer periphery of the cladding layer 22Bb. The core portion 22Ba has an apical surface 22Baa. Herein, the output-type optical fiber 22B is assumed to be a multimode optical fiber having the NA to be equal to or greater than the NA of the input-type optical fibers 21.

The output-type optical fiber 22B includes an isodiametric portion 22BA, a tapered portion 22BB, and an isodiametric portion 22BC. The isodiametric portion 22BA, the tapered portion 22BB, and the isodiametric portion 22BC are arranged in that order with reference to the apical surface 22Baa. The tapered portion 22BB is formed in the output-type optical fiber 22B and is a tapered portion in which the cross-sectional area of the output-type optical fiber 22B is tapered to become narrower in the light traveling direction. The isodiametric portions 22BA and 22BC are isodiametric portions in which the cross-sectional area of the output-type optical fiber 22B remains substantially equal in the light traveling direction.

The resin covering layer 22Bc is removed in the portion spanning over a predetermined length from the apical surface 22Baa and in the portion spanning from the tapered portion 22BB up to midway of the isodiametric portion 22BC.

The seven input-type optical fibers 21 are bundled at the leading end side to form fiber bundle portions 21E, 21F, and 21G. From midway of the fiber bundle portion 21E and across the fiber bundle portions 21F and 21G, the resin covering layer 21c is removed. The fiber bundle portion 21G that represents the leading end portion among the fiber bundle portions 21E, 21F, and 21G is connected to the output-type optical fiber 22B. Herein, the fiber bundle portion 21G and the output-type optical fiber 22B are fusion-spliced at apical surfaces 21Ga and 22Baa.

The fiber bundle portion 21F is a tapered portion. The fiber bundle portion 21G is an isodiametric portion. That is, in the optical coupler 20B, a single tapered portion is formed in the seven input-type optical fibers 21.

Thus, in the optical coupler 20B, a single tapered portion is formed in the input-type optical fibers 21 and a single tapered portion is formed in the output-type optical fiber 22B. Thus, a total of two tapered portions are formed. The tapered portion 22BB and the fiber bundle portion 21F represent an example of two or more tapered portions.

The radiant light processing unit 23a is placed to enclose the outer periphery of the portion covering the fiber bundle portion 21G and the isodiametric portion 22BA. That is, the radiant light processing unit 23a is disposed to partially overlap with the fiber bundle portion 21G, which is an isodiametric portion, in the light traveling direction; and is disposed in some part of the outer periphery of the seven input-type optical fibers 21 and the output-type optical fiber 22B.

The radiant light processing unit 23b is disposed to enclose the outer periphery of the portion covering some part of the tapered portion 22BB up to midway of the isodiametric portion 22BC. That is, the radiant light processing unit 23b is disposed to partially overlap with the tapered portion 22BB in the light traveling direction; and is disposed in some part of the outer periphery of the output-type optical fiber 22B.

In the optical coupler 20B configured in the manner explained above, because of the two tapered portions, namely, the fiber bundle portion 21F and the tapered portion 22BB, it becomes possible to enhance the luminance of the multiplexed light that is obtained by multiplexing the laser lights input from the seven input-type optical fibers 21.

Moreover, the laser light L1 that is generated in the fiber bundle portion 21F and that has a large radiation angle may be efficiently retrieved from the fiber bundle portion 21G and the isodiametric portion 22BA using the radiant light processing unit 23a. In an identical manner, the laser light L2 that is generated in the tapered portion 22BB and that has a large radiation angle may be efficiently retrieved from the isodiametric portion 22BC using the radiant light processing unit 23b. That enables holding down a decline in the reliability of the optical coupler 20B.

As explained above, the optical coupler 20B according to the second embodiment is suitable in enhancing the luminance of the input laser light and is prevented from undergoing a decline in reliability. The light source device 10 that includes the optical coupler 20B is capable of outputting a high-luminance laser light from the machining head 30 and is prevented from undergoing a decline in device reliability.

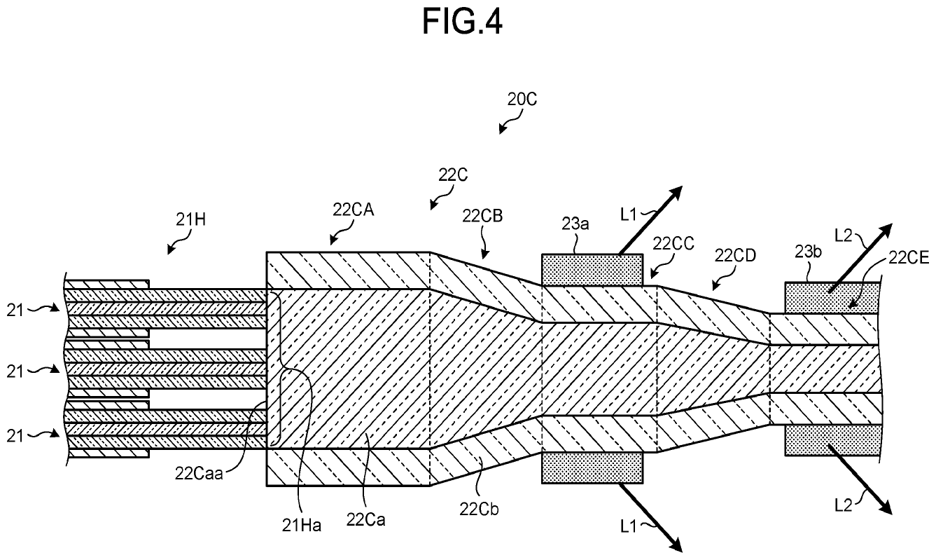

FIG. 4 is a schematic diagram of an optical coupler according to a third embodiment. An optical coupler 20C may be used in place of the optical coupler 20A in the light output device 100.

The optical coupler 20C includes the seven input-type optical fibers 21, an output-type optical fiber 22C, and the radiant light processing units 23a and 23b. Herein, the configuration and the arrangement of the seven input-type optical fibers 21 as well as the definition of the light traveling direction is identical to the optical couplers 20A and 20B. Hence, that explanation is not given again.

The output-type optical fiber 22C includes a core portion 22Ca, a cladding layer 22Cb formed on the outer periphery of the core portion 22Ca, and a resin covering layer (not illustrated) formed on the outer periphery of the cladding layer 22Cb. The core portion 22Ca has an apical surface 22Caa. The output-type optical fiber 22C is assumed to be a multimode optical fiber having the NA to be equal to or greater than the NA of the input-type optical fibers 21.

The output-type optical fiber 22C includes an isodiametric portion 22CA, a tapered portion 22CB, an isodiametric portion 22CC, a tapered portion 22CD, and an isodiametric portion 22CE. The isodiametric portion 22CA, the tapered portion 22CB, the isodiametric portion 22CC, the tapered portion 22CD, and the isodiametric portion 22CE are arranged in that order with reference to the apical surface 22Caa. The tapered portions 22CB and 22CD are formed in the output-type optical fiber 22C and are tapered portions in which the cross-sectional area of the output-type optical fiber 22C is tapered to become narrower in the light traveling direction. The isodiametric portions 22CA, 22CC, and 22CE are isodiametric portions in which the cross-sectional area of the output-type optical fiber 22C remains substantially equal in the light traveling direction. That is, in the optical coupler 20C, two tapered portions are formed in the output-type optical fiber 22C. The tapered portions 22CB and 22CD represent an example of two or more tapered portions.

The seven input-type optical fibers 21 are bundled at the leading end side to form a fiber bundle portion 21H. From midway of the fiber bundle portion 21H, the resin covering layer is removed. The fiber bundle portion 21H does not have a tapered portion, and the cross-sectional area of each of the seven input-type optical fibers 21 remains substantially equal in the light traveling direction. The fiber bundle portion 21H is connected to the output-type optical fiber 22C. Herein, the fiber bundle portion 21H and the output-type optical fiber 22C are fusion-spliced at apical surfaces 21Ha and 22Caa.

The radiant light processing unit 23a is formed to enclose the outer periphery of the isodiametric portion 22CC. That is, the radiant light processing unit 23a is placed away from the tapered portion 22CB in the light traveling direction, and is placed on some part of the outer periphery of the output-type optical fiber 22C.

The radiant light processing unit 23b is formed to enclose the outer periphery of the isodiametric portion 22CE. That is, the radiant light processing unit 23a is placed away from the tapered portion 22CD in the light traveling direction, and is placed on some part of the outer periphery of the output-type optical fiber 22C.

In the optical coupler 20C configured in the manner explained above, because of the two tapered portions 22CB and 22CD, it becomes possible to enhance the luminance of the multiplexed light that is obtained as a result of multiplexing the laser lights input from the seven input-type optical fibers 21.

Moreover, the laser light L1 that is generated in the tapered portion 22CB and that has a large radiation angle may be efficiently retrieved from the isodiametric portion 22CC using the radiant light processing unit 23a. In an identical manner, the laser light L2 that is generated in the tapered portion 22CD and that has a large radiation angle may be efficiently retrieved from the isodiametric portion 22CE using the radiant light processing unit 23b. That enables holding down a decline in the reliability of the optical coupler 20C.

As explained above, the optical coupler 20C according to the third embodiment is suitable in enhancing the luminance of the input laser light and is prevented from undergoing a decline in reliability. The light source device 10 that includes the optical coupler 20C is capable of outputting a high-luminance laser light from the machining head 30 and is prevented from undergoing a decline in device reliability.

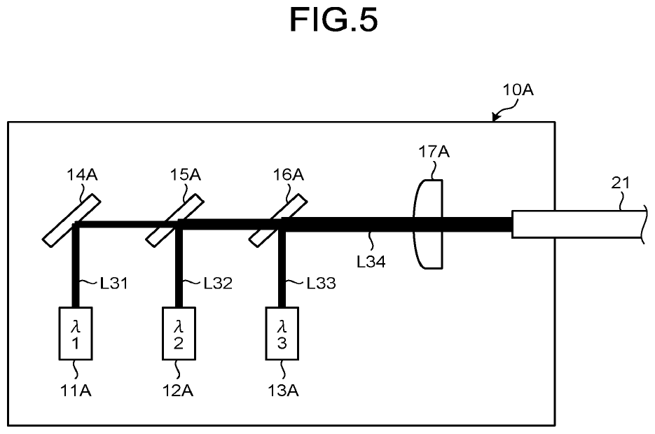

FIG. 5 is a diagram illustrating an exemplary configuration of a light source device. A light source device 10A may be used as at least one of a plurality of light source devices 10 illustrated in FIG. 1. The light source device 10A includes: semiconductor laser devices 11A, 12A, and 13A representing an example of a plurality of light emitting devices; photonic devices 14A, 15A, and 16A; and a collecting lens 17A.

Each of the semiconductor laser devices 11A, 12A, and 13A includes a high-output multimode semiconductor laser element and a collimation lens. The semiconductor laser devices 11A, 12A, and 13A output laser lights L31, L32, and L33, respectively. The laser lights L31, L32, and L33 have mutually different wavelengths, namely, wavelengths λ1, λ2, and λ3, respectively.

The photonic device 14A reflects the laser light L31 toward the photonic device 15A. The photonic device 15A lets through the laser light L31 toward the photonic device 16A, and reflects the laser light L32 toward the photonic device 16A. The photonic device 16A lets through the laser lights L31 and L32 toward the collecting lens 17A, and reflects the laser light L33 toward the collecting lens 17A. As a result, a multiplexed light L34 is generated due to multiplexing of the laser lights L31, L32, and L33 having mutually different wavelengths. The collecting lens 17A collects the multiplexed light L34 and couples it with the input-type optical fibers 21. Thus, the photonic devices 14A, 15A, and 16A function as optical multiplexers that multiplex the laser lights L31, L32, and L33 having mutually different wavelengths, and output the multiplexed light to the input-type optical fibers 21.

In the light source device 10A, the laser lights L31, L32, and L33 coming from the semiconductor laser devices 11A, 12A, and 13A, respectively, may be input to the input-type optical fibers 21. Hence, it is desirable to use the light source device 10A from the perspective of achieving high luminance. Moreover, since the laser lights L31, L32, and L33 may be input without any increase in the incidence angle with respect to the input-type optical fibers 21, it is desirable to use the light source device 10A also from the perspective of holding down the generation of radiant light in the tapered portions of the optical coupler.

In this way, it is desirable to use a light source device that may reduce the incidence angle with respect to the input-type optical fibers in such a way that the radiation angle from the input-type optical fibers is smaller than the NA of the output-type optical fiber in the optical coupler. For example, it is suitable to use a light source device which includes a luminance conversion unit and in which a fiber laser is used that is capable of outputting a high-quality single-mode light (a light having a small radiation angle).

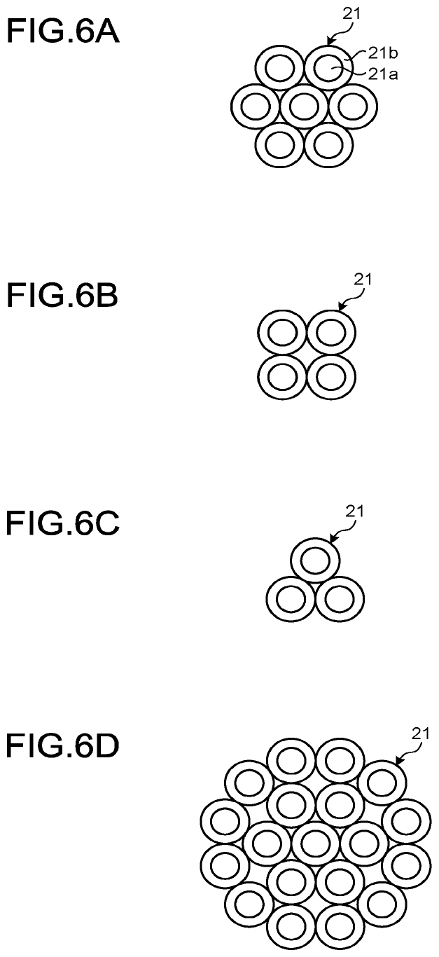

FIGS. 6A to 6D are diagrams illustrating examples of the arrangement of the input-type optical fibers. In the embodiments described above, as illustrated in FIG. 6A, the seven input-type optical fibers 21, each of which includes the core portion 21a and the cladding layer 21b, are arranged to achieve the closest packing arrangement. However, the arrangement of the input-type optical filter 21 is not limited to that example.

Alternatively, for example, in FIG. 6B is illustrated an example in which four input-type optical fibers 21 are arranged in a square shape. In FIG. 6C is illustrated an example in which three input-type optical fibers 21 are arranged to achieve the closest packing arrangement. In FIG. 6D is illustrated an example in which 12 input-type optical fibers 21 are arranged in a toric manner on the outer periphery of the arrangement illustrated in FIG. 6A.

In order to minimize the core diameter of the output-type optical fiber and to achieve higher power density (higher luminance), it is desirable that the input-type optical fibers are arranged to nearly achieve the closest packing arrangement and to have a circular outer periphery. Although there is no particular restriction on the number of input-type optical fibers, it is desirable to have three, or seven, or 19 input-type optical fibers. That is because a high level of position stability is achieved when the input-type optical fibers are bundled together.

In the embodiments described above, the radiant light processing unit 23a is made of a light-removal-type resin. Alternatively, a radiant light processing unit may be implemented in various other forms.

For example, a radiant light processing unit may include a fusion-type optical coupler. For example, on the outer periphery of an input-type optical fiber or an output-type optical fiber in which a radiant light processing unit is to be installed, an optical fiber for radiant light transmission may be welded along the outer periphery, and a fusion-type optical coupler may be configured.

Moreover, for example, the radiant light processing unit may include a corrugated portion provided on the outer periphery of the input-type optical fiber or the output-type optical fiber. Such a corrugated surface may be formed either by performing surface roughening on the input-type optical fiber or the output-type optical fiber, or by pressing a material having a corrugated surface onto the outer periphery of the input-type optical fiber or the output-type optical fiber.

Herein, although the present disclosure is described with reference to the abovementioned embodiments for a complete and clear disclosure, the appended claims are not to be thus limited but are to be construed as embodying all modifications and alternative constructions that may occur to one skilled in the art that fairly fall within the basic teaching herein set forth.

For example, when a plurality of tapered portions having different taper ratios is present, it is not mandatory to have isodiametric portions in between the tapered portions. Moreover, radiant light processing units may be disposed in a corresponding manner to the boundary portions of a plurality of tapered portions having different taper ratios. In that case, it becomes possible to process the laser lights leaking from the boundary portions.

According to the present disclosure, it becomes possible to implement an optical coupler that is suitable in enhancing the luminance of the laser light and that is capable of dealing with the radiant light in an appropriate manner, and to implement a light output device in which the optical coupler is used.

Although the disclosure has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. An optical coupler comprising:
a plurality of input-type optical fibers;
an output-type optical fiber; and
two or more radiant light processing units, wherein
the plurality of input-type optical fibers are bundled at leading end side to form a fiber bundle portion, and leading end portion of the fiber bundle portion is connected to the output-type optical fiber,
in at least either the plurality of input-type optical fibers or the output-type optical fiber, a tapered portion is formed in which cross-sectional area is tapered to become narrower in light traveling direction indicating direction from the plurality of input-type optical fibers toward the output-type optical fiber,
number of the tapered portion is equal to or greater than two, and
each of the two or more radiant light processing units is disposed to mutually overlap with one of the two or more tapered portions in the light traveling direction or is disposed away from one of the two or more tapered portions in the light traveling direction, and is disposed on outer periphery of the plurality of input-type optical fibers or outer periphery of the output-type optical fiber.

2. The optical coupler according to claim 1, wherein the radiant light processing unit is made of a light-removal-type resin.

3. The optical coupler according to claim 1, wherein the radiant light processing unit is made of a fusion-type optical coupler.

4. The optical coupler according to claim 1, wherein the radiant light processing unit has a corrugated portion formed on outer periphery of the plurality of input-type optical fibers or outer periphery of the output-type optical fiber.

5. A light output device comprising:
a plurality of light source devices; and
the optical coupler according to claim 1, wherein
the plurality of light source devices and the plurality of input-type optical fibers are so connected that light output from each of the plurality of light source devices is input to one of the plurality of input-type optical fibers.

6. The light output device according to claim 5, wherein at least one of the plurality of light source devices includes
a plurality of light emitting devices that outputs lights having mutually different wavelengths, and
an optical coupler that multiplexes the lights having mutually different wavelengths and outputs multiplexed light to the input-type optical fibers.
